(19) United States
(12) Patent Application Publication
(10) Pub. No.: US 2026/0028083 A1
(43) Pub. Date: Jan. 29, 2026

(54) MONITORING DEVICE AND METHOD FOR MONITORING

(71) Applicant: Porsche eBike Performance GmbH, Ottobrunn (DE)

(72) Inventors: Dennis Fischer, Hirschhorn (DE); Mikel Fauri, Ludwigsburg (DE); Stefan Bender, Loechgau (DE)

(73) Assignee: Porsche eBike Performance GmbH, Ottobrunn (DE)

(21) Appl. No.: 18/993,543

(22) PCT Filed: Jul. 7, 2023
(86) PCT No.: PCT/EP2023/068892

§ 371 Date: Jan. 11, 2025

(30) Foreign Application Priority Data
Jul. 13, 2022 (DE) 10 2022 117 411.5

(51) Int. Cl. B62J 45/42; B62J 27/00; B62K 23/06; B62L 3/02

(52) U.S. Cl. CPC B62J 45/42; B62J 27/00; B62K 23/06; B62L 3/02

(57) ABSTRACT

A vehicle (1) has a steering device (5) for steering the vehicle (1), a handle (6) that enables the driver to hold the steering device (5) with one hand, a brake (7) for braking the vehicle (1) and a brake actuating element (8) for actuating the brake (7) of the vehicle (1). The vehicle (1) also has a monitoring device (9) for monitoring the driver of the vehicle (1). The monitoring device (9) includes a monitoring sensor (10) that is provided in or on the brake actuating element (8). The monitoring sensor (10) monitors whether the handle (6) is gripped by a hand.

### FIELD OF THE INVENTION

The invention relates to a monitoring device, a vehicle having a monitoring device and a method for monitoring.

### BACKGROUND OF THE INVENTION

Vehicles are known in the prior art, for example two-wheelers, in particular bicycles, electrically assisted bicycles, electrically powered bicycles, also known as electric bicycles, e-bikes, pedelecs or S-pedelecs, etc. The rider sits on the vehicle while riding, but the rider typically leaves the vehicle in the event of an accident, for example in the event of a fall. A fall can have significant consequences for the health of the rider or any passenger, and an automated emergency call would certainly be desirable in some accident situations.

U.S. Pat. No. 7,658,256 discloses an impact detection sensor of a motorcycle that detects an impact in the event of an accident and triggers an airbag based on a detected impact of the motorcycle in order to protect the rider of the motorcycle. These impact detection sensors are located on both sides of the rear of the front fork and act as acceleration sensors to detect the acceleration in the event of an impact. The impact signal then is evaluated by a control unit and a decision is made as to whether the impact signal generated is the result of a collision or not. Such a system is relatively expensive and also relatively unsuitable for a bicycle because the impacts that occur when riding the bicycle, especially when riding off the road, can be relatively strong, making it difficult to distinguish between such impacts and an accident.

DE 10 2016 225 489 B4 discloses a pedelec that has an acceleration sensor and a radar sensor. The radar sensor monitors the distance to an object and the acceleration sensor monitors any accelerations acting on the pedelec. A hazardous situation or an accident is detected if the distance to an object falls below a suitable level and if the acceleration exceeds a suitable level. The use of a radar sensor is considered to be expensive and permanently maintenance-intensive. Additionally, the reliability of the radar signal for accident detection leaves much to be desired.

DE 10 202 201 221 1 discloses a method for checking the plausibility of an accident situation on a two-wheeler or electric bicycle, in which a sensor variable of a first sensor, by which an accident situation is detected, is checked by a sensor variable of a second sensor. The output of an accident situation is prevented depending on the sensor variable of the second sensor. The second sensor variable that monitors the movement, operation or condition of the two-wheeler or electric bicycle is detected, and the second sensor variable is determined only when the accident information is available from the first sensor. As a result, attention is basically only paid to data relating to the two-wheeler. These data are used to trigger an automated emergency call, and can also lead to false conclusions.

An object of the invention is to create a monitoring device, a vehicle having a monitoring device and a method for monitoring, that are improved compared to the prior art and allow a more reliable generation of an automated emergency call signal.

### SUMMARY OF THE INVENTION

One exemplary embodiment of the invention relates to a monitoring device of a vehicle for monitoring the driver of the vehicle. The vehicle comprises a steering device for steering the vehicle, a handle enabling the driver to hold the steering device of the vehicle with one hand, a brake for braking the vehicle, and a brake-actuating element for actuating the brake of the vehicle. A monitoring sensor also is provided is provided in or on the brake actuating element and monitors whether the handle is gripped by a hand. The vehicle may be a two-wheeler, a three-wheeler or a four-wheeler, in particular a bicycle, an electric bicycle, a pedelec, an S-pedelec, an e-bike, etc. The monitoring of some embodiments is carried out based on the assumption that the rider basically holds the handle in their hand constantly or holds the handle in their hand apart from brief exceptions, in order to hold on to the handle and to be able to steer and brake. A gear shift and/or the actuation of additional functions also often takes place on the handle or in its vicinity. This aspect of the invention monitors whether the hand is on the handle so that it can be assumed that a normal operating situation exists in this case. If, on the other hand, the hand is not on the handle for a longer period of time and further information and/or sensor signals are present, it can be concluded that an accident or fall has occurred so that an emergency signal can be generated and sent.

In a further exemplary embodiment, the monitoring sensor generates a sensor signal that represents whether or not the handle is gripped by a hand. This is done, for example, in such a way that the sensor compares data that was recorded with a hand on the handle and the handle without a hand, or the sensor can directly detect the handle without a hand and a hand on the handle due to a 3-dimensional resolution. For example, a measurement of the handle without a hand can be carried out as a calibration that can be done when the handle is installed or when the handle is replaced, for example.

It is also advantageous if the monitoring sensor is an optical sensor, in particular an optical sensor based on the time-of-flight principle. The optical sensor can be used, for example, to take images that can be compared with a reference image. The time-of-flight sensor can generate a 3-dimensional image that allows the hand on the handle or only the handle to be recognized directly or in comparison with a reference image.

The steering device of some embodiments is a handlebar and the brake-actuating element is a brake lever. For example, it can be used on a bicycle.

One exemplary embodiment of the invention relates to a vehicle having at least two wheels, a steering device for steering the vehicle, at least one handle enabling the driver to hold the steering device of the vehicle with one hand, at least one brake for braking the vehicle, and at least one brake-actuating element for actuating the brake of the vehicle. The vehicle of this embodiment also has at least one monitoring device as described herein for monitoring the driver of the vehicle. In this way, the driver can be monitored reliably.

It is particularly advantageous if two handles are provided for holding the steering device of the vehicle by the respective hands of the driver and at least two brake-actuating elements are provided for actuating at least one brake of the vehicle. At least one monitoring device, preferably two monitoring devices, is or are provided for monitoring the driver of the vehicle. This aspect of the invention can provide a higher level of monitoring reliability.

It is also useful if the vehicle is a two-wheeler, a three-wheeler or a four-wheeler, in particular a bicycle, an electric bicycle, a pedelec, an S-pedelec, an e-bike, etc. The rider can be monitored in a variety of ways.

Another exemplary embodiment of the invention relates to a method for operating a monitoring device described herein in a vehicle as described herein. In accordance with some aspects of the method, the sensor signal of the at least one monitoring sensor is repeatedly, in particular periodically over time, interrogated or checked to monitor whether at least one hand of the driver is on the handle. This ensures that the driver is present in an operating situation that can be described as normal. If this is the case, the generation and transmission of an emergency signal can be dispensed with.

In a further exemplary embodiment, it is also useful if an emergency signal is sent in the event that at least one hand of the driver is no longer detected or no hand of the driver is detected on the handle. If the driver cannot be detected on the handle according to the monitoring of the handle, an emergency signal can be generated and sent.

In the following, the invention is explained in detail by means of an exemplary embodiment with reference to the drawing.

### BRIEF DESCRIPTION OF THE DRAWINGS

FIG. 1 is a schematic representation of an exemplary embodiment of a vehicle according to the invention, in particular a bicycle with electric drive assistance.

FIG. 2 is a schematic perspective view of an exemplary embodiment of a steering device with a handle and a brake-actuating element with a monitoring sensor.

### DETAILED DESCRIPTION

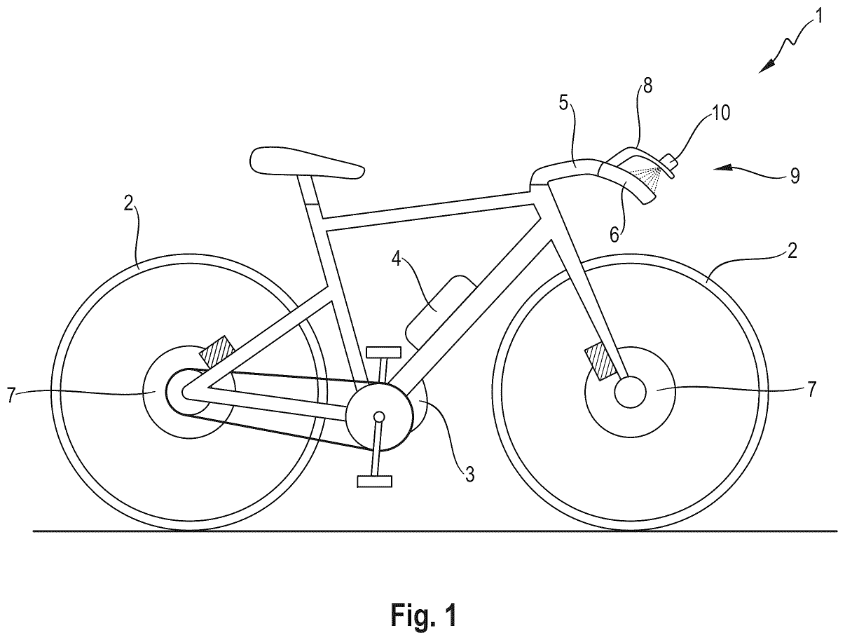

FIG. 1 shows a schematic representation of a vehicle 1. The vehicle 1 is shown as a two-wheeler with two wheels 2. However, it can also be designed in other ways, for example as a three-wheeler, a four-wheeler, etc., wherein the number of wheels 2, their size, etc. is not important in the embodiment according to the invention.

The vehicle 1 is shown as a bicycle that, for example, also has electric drive assistance with an electric motor 3 and an electric energy store 4, such as an accumulator. The bicycle can therefore be an electric bicycle, a pedelec, an S-pedelec, an e-bike, etc. The bicycle can also be designed without such an electric drive assistance system.

The vehicle 1 shown has at least two wheels 2. It also has a steering device 5 for steering the vehicle 1. The steering device 5 is designed with at least one handle 6, preferably with two handles 6, enabling the driver of the vehicle 1 to hold the steering device 5 of the vehicle 1 with one hand.

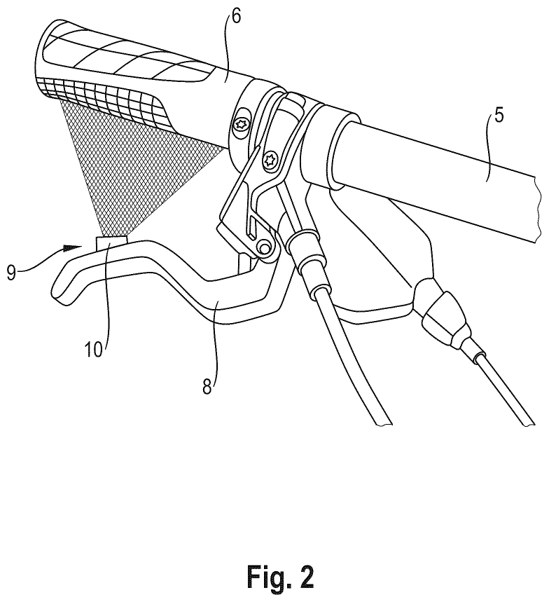

Furthermore, the vehicle 1 is designed with at least one brake 7 for braking the vehicle 1, and at least one brake-actuating element 8 is provided for actuating the brake 7 of the vehicle 1. The brake-actuating element 8 is preferably a brake lever, as can be seen in FIG. 2.

Furthermore, at least one monitoring device 9 with a monitoring sensor 10 is provided for monitoring the driver of the vehicle 1.

Advantageously, at least one monitoring device 9 is provided, preferably two monitoring devices 9, so that, for example, one monitoring sensor 10 or two or more monitoring sensors are provided. Preferably, one monitoring sensor 10 is provided per brake-actuating element 8 or one monitoring sensor 10 per brake-actuating element 8 per handle 6.

The vehicle 1 shown in FIG. 1 has two handles 6 for holding the steering device 5 of the vehicle 1 in order to be able to grip the two handles 6 with one hand each, i.e., in order for the driver to grip the steering device 5 with both hands.

Preferably, at least two brake-actuating elements 8 also are provided for actuating at least one brake 7 of the vehicle 1

The monitoring device 9 is used to monitor the driver of the vehicle 1 and has a monitoring sensor 10 that monitors whether the handle 6 is gripped by a hand.

The monitoring sensor 10 generates a sensor signal that represents whether or not the handle 6 is gripped by a hand. This sensor signal is generated and forwarded to indicate a possible emergency situation.

The monitoring sensor 10 is an optical sensor. Preferably, the monitoring sensor 10 is an optical sensor based on the time-of-flight principle. Such an optical sensor based on the time-of-flight principle emits light, for example infrared light. The emitted light strikes an object, where it is reflected and returns to the monitoring sensor 10. The time it takes to return is measured and evaluated. This allows a three-dimensional structure of the reflecting object to be determined. When used as a monitoring sensor 10, either the empty handle 6 or a handle 6 grasped by a hand can be detected accordingly, so that the presence of the driver can be inferred.

The method for operating a monitoring device 9 in a vehicle 1 provides, for example, that the sensor signal of the at least one monitoring sensor 10 is repeatedly, in particular periodically, interrogated or checked to monitor whether at least one hand of the driver is on the handle 6. This also makes it possible to detect that the hand is only briefly not on the handle 6, for example, to avoid false signals.

Accordingly, an emergency signal can be sent in the event that at least one of the driver's hands is no longer recognized or none of the driver's hands are recognized on the handle 6.

The emergency signal can, for example, only be sent if, in addition, a predeterminable waiting time has elapsed and/or another sensor signal from another sensor has detected an accident and/or fall and the emergency signal has not been deactivated manually.

Accordingly, the transmission of an emergency signal can be prevented, for example by pressing a button, if an emergency signal is sent undesirably. Otherwise, if the necessary conditions are met, an emergency signal would be sent, for example by radio or telecommunication.

1. A monitoring device (9) for monitoring driver of a vehicle (1), the vehicle comprising a steering device (5) for steering the vehicle (1), a handle (6) enabling the driver to hold the steering device (5) of the vehicle (1) with one hand, a brake (7) for braking the vehicle (1), and a brake-actuating element (8) for actuating the brake (7) of the vehicle (1), wherein the monitoring device (9) comprises a monitoring sensor (10) provided in or on the brake-actuating element (8) and monitoring whether the handle (6) is gripped by a hand.

2. The monitoring device (9) of claim 1, wherein the monitoring sensor (10) generates a sensor signal that represents whether or not the handle (6) is gripped by a hand.

3. The monitoring device (9) of claim 1, wherein the monitoring sensor (10) is an optical sensor.

4. The monitoring device (9) of claim 1, wherein the steering device (5) is a steering rod and the brake-actuating element (8) is a brake lever.

5. A vehicle (1) comprising at least two wheels (2), a steering device (5) for steering the vehicle (1), at least one handle (6) enabling the driver to hold the steering device (5) of the vehicle (1) with one hand, at least one brake (7) for braking the vehicle (1), at least one brake-actuating element (8) for actuating the brake (7) of the vehicle (1), and at least one monitoring device (9) for monitoring the driver of the vehicle (1), the at least one monitoring device (9) comprising a monitoring sensor (10) provided in or on the brake-actuating element (8) and monitoring whether the handle (6) is gripped by a hand.

6. The vehicle (1) of claim 5, wherein the steering device (6) has two handles (6) for being held respectively by two hands of the driver, and the steering device (5) of the vehicle (1) further comprising at least two brake-actuating elements (8) for actuating the at least one brake (7) of the vehicle (1), and the at least one monitoring device (9), being provided with a monitoring sensor (10) for monitoring the driver of the vehicle (1).

7. The vehicle (1) of claim 6, wherein the vehicle (1) is a two-wheeler, a three-wheeler or a four-wheeler, a bicycle, an electric bicycle, a pedelec, an S-pedelec, or an e-bike

8. A method for operating a monitoring device (9) of a vehicle (1) for monitoring the driver of the vehicle (1), the vehicle comprising a steering device (5) for steering the vehicle (1), a handle (6) enabling the driver to hold the steering device (5) of the vehicle (1) with one hand, a brake (7) for braking the vehicle (1), a brake-actuating element (8) for actuating the brake (7) of the vehicle (1), a monitoring sensor (10) provided in or on the brake-actuating element (8) and monitoring whether handle (6) is gripped by a hand, wherein the method comprises: causing the monitoring sensor (10) to generate a sensor signal repeatedly or periodically in time and interrogating or checking the monitoring sensor (10) to monitor whether at least one hand of the driver is on the handle (6).

9. The method claim 8, further comprising s an emergency signal if at least one hand of the driver is no longer detected or no hand of the driver is detected on the handle (6).

10. The method of claim 9, wherein the emergency signal is only sent if, in addition, a predeterminable waiting time has elapsed and/or a further sensor signal from a further sensor has detected an accident and/or fall and, in addition, the emergency signal has not been deactivated manually.
